(19) United States
(12) Patent Application Publication
(10) Pub. No.: US 2004/0113753 A1
(43) Pub. Date: Jun. 17, 2004

(54) System for controlling the key-lock switch

(76) Inventor: Eden Jung-Yu Chen, Tu Chen City (TW)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/718,718

(22) Filed: Nov. 24, 2003

(30) Foreign Application Priority Data
Nov. 26, 2002 (TW) 91134375

(51) Int. Cl. H04Q 1/00

(52) U.S. Cl. 340/5.7

(57) ABSTRACT

The invention is a system for controlling the key-lock switch by output or cutoff the electronic control signals to switch the key-lock device through editing the received/transmitted information data via spread frequency digital modulation/demodulation. The confidentiality and privacy is even re-enforced when the received/transmitted information data is further protected through encryption and decryption process. The system includes: a. at least an electronic key which is operable to transfer the information data, and the information data is transmitted in the form of radio frequency signal after being edited by baseband coding technology and digital-to-analog convert technology; and b. at least a key-lock control nodule which receives the radio frequency signals, decoded by baseband analog-to-digital convert technology and coding technology, and reedit into information data, and then the information data is as certified data which will be checked and compared one by one by identifying program with the certified data table contained in the memory. If it is identified as the same certified data, the key-lock control module will output or cut-off the electronic control signals to open, to close or to switch the key-lock device from open to lock or from lock to open.

### BACKGROUND

1. Field of the Invention

The invention relates to a method and system for controlling the key-lock switch system. Especially for the system that controls the on/off/switch action of key-lock device by exchanging the information data be received and transmitted via spread frequency digital modulation/demodulation.

2. Description of the Prior Art

For the sake of security, the buildings are usually equipped with key-lock at the passage to control the entrance of persons with different authority. Among those various methods, there are defects of being easily duplicated found on the metal key for mechanical door key-lock & the stripe card of magnetic key-lock device; being easily damaged found on the stripe card of magnetic key-lock device the stripe card of magnetic key-lock device; and being easily peeped on the digital key-lock when the user is pressing the numbers.

Besides, there are key-lock system by wireless control which uses non-touch IC card to control the key-lock system. Like the key-locks used in the passage of parking lots, it is not easily duplicated but the available distance of the sensor is very limited

The key-locks for most vehicles use wireless radio frequency signals transferring, such as AM (Amplitude Modulation) by amplified size and FM (Frequency Modulation) by frequency speed. Both AM & FM wireless signals need large wave bandwidth that limits the number of changeable codes and the length of signal data. Also there are unsolved defects of noise interference.

The key-locks use infrared technology is with defects of directional requirement which the light resource and light reception area must be directly faced for smooth transferring, and of being easily stopped by obstacles.

### SUMMARY

The invention relates to a method and system for controlling the key-lock switch system by using spread frequency type digital modulation and demodulation technology to handle receiving and transmitting of the data to be exchanged. The technology is with features of high confidentiality and small interference, and the confidentiality and privacy is even re-enforced through encryption and decryption process to further protect the data.

To reach the above-mentioned target, the system will include: at least an electronic key comprising an RF and an antenna that are located in the transmitting end through which the information data of the electronic key is transmitted after being generated by encryption program and coded by spread frequency digital modulation as radio frequency signal;

And at least a key-lock control module comprising an RF and an antenna that are located in the receiving end through which the radio frequency signals are received and re-edited into information data by spread frequency digital demodulation, and then the information data is generated by decryption program as certified data which will be checked and compared one by one by identifying program with the certified data table contained in the memory. If it is identified as the same certified data, the key-lock control module will output or cut-off the electronic control signals to switch the key-lock device. And will save the executed control contents and time as recorded data to show the entering, outing, usage situation and etc.

### BRIEF DESCRIPTION OF THE DRAWINGS

FIG. 1 shows the first example of the invented key-lock switch system.

FIG. 2 is a combination drawing for the invented electronic key and the key-lock control module.

FIG. 3 is a one by multiple combinations drawing for the invented electronic key and the key-lock control module.

FIG. 4 shows the second example of the invented key-lock switch system.

FIG. 5 is the third example for the invention of key-lock switch system and explains how to renew the data content of operator's table of the electronic key.

FIG. 6 is the forth example of the invention and explains the management and maintenance of the invented key-lock switch system.

FIG. 7 explains an example of how the invention applied in a building

FIG. 8 explains an example used in motorcycles.

FIG. 9 explains an example that the invention used in a car.

### DESCRIPTION OF THE PREFERRED EMBODIMENT

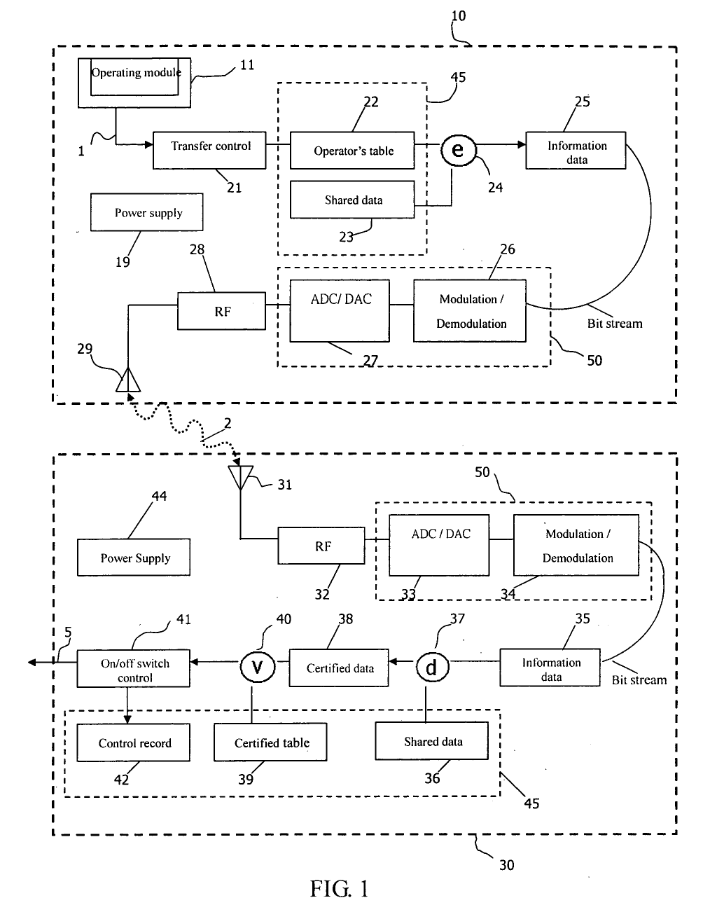

Regarding the invention of key-lock switch system, please refer to the FIG. 1 which shows the first example of the invention, which includes at least an electronic key 10 and at least a key-lock control module 30. In the electronic key 10, the power supply 19 provides electric circuits and power needed by all components; the memory 45 stores the necessary data and shared data 23 for operator's table 22; the operating module 11 is for the operator via which to transfer control 21 the electronic signal enters 1 and monitor the operator's action. When the electronic signal enters 1, it will start the necessary transmitting action. First transfer control 21 will read the corresponding data of the operator's table 22 and the shared data 23 from the encryption program 24 to edit the information data 25. The information data 25 will be transferred into radio frequency signals 2 through modulation/demodulation 26's coding technology of spread frequency type digital modulation and DAC/ADC 27's digital to analog convert technology under the baseband 50. RF 28 will transmit the coded radio frequency signals into the air via the antenna 29.

Of the key-lock control module 30 composition, the power supply 44 provides electric circuit and the necessary power for the components, RF 32 and antenna 31 receive the radio frequency signals 2 from the air and edit into information data 35 by the coding process of DAC/ADC 33's analog to digital convert technology and modulation/demodulation 34's spread frequency type digital demodulation technology under the baseband 50. The memory 45 stored the certified table 39 data for identifying and action control, shared data 36 and the control record for recording the time and control action. The decryption program 37 edits the received information data 35 and shared data 36 into certified data 38 for identifying program 40 which identifies the certified data 38 with the data of the certified table 39 one by one. If there is a data be identified as the same, according to the identification result, the on/off switch control 41 will output or cutoff the control electronic signals 5 to the key-lock module 30 of the key-lock for on/off action control and save the time and action as a control record 42 for management purpose.

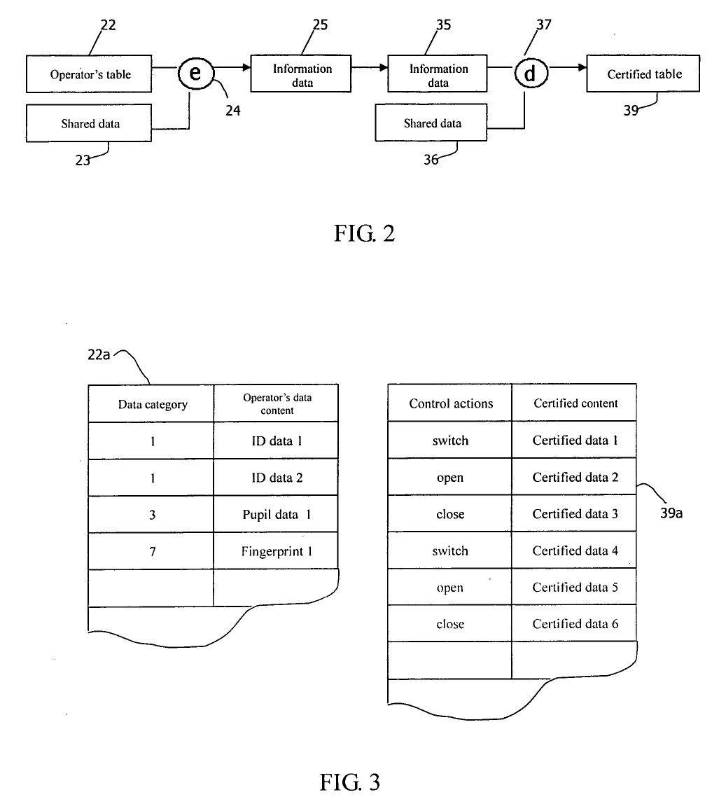

The FIG. 2 explains how the saved certified data of the certified table 39 of the key-lock control module 30 is produced. By encryption program 24, every data is edited from same as the shared data 23 and the operator's table 22 of the electronic key 10 which is corresponding to the key-lock control module 30. The edited information data 35 and the shared data 36 of the key-lock control module 30 is re-edited by decryption program 37. The re-edited data is saved into the certified table 39 for the sake of being identified one by one with the information data 25 of electronic key 10. Thus, the matching model of the electronic key 10 and the key-lock control module 30 is unique and will not be duplicated.

FIG. 3 explains the operator's table 22 and certified table 39 stored in the memory. The operator's table example 22a of electronic key 10 is stored with data category and operator's data contents. The data category specifies the type of data contents and the data content is used to control the key-lock. The certified table example 39a of key-lock control module 30 is stored with control action and certified data contents. Through identifying with the certified data content, the on/off switch control 41 will output or cutoff control electric signals 5 as corresponded indicate content of the control action.

The operator's table 22 of an electronic key is able to be stored lots of data to correspond with the many different key-lock control module 30s. The certified table 39 of the key-lock control module 30 also is able to be stored many of certified data by the way explained in FIG. 2 to correspond with the many different electronic key 10s. Thus, the electronic key 10 and the key-lock control module 30 may be a combination of one electronic key 10 controls multiple key-lock control module 30 or of one key-lock control module 30 corresponds with multiple electronic key 10 besides the one by one combination.

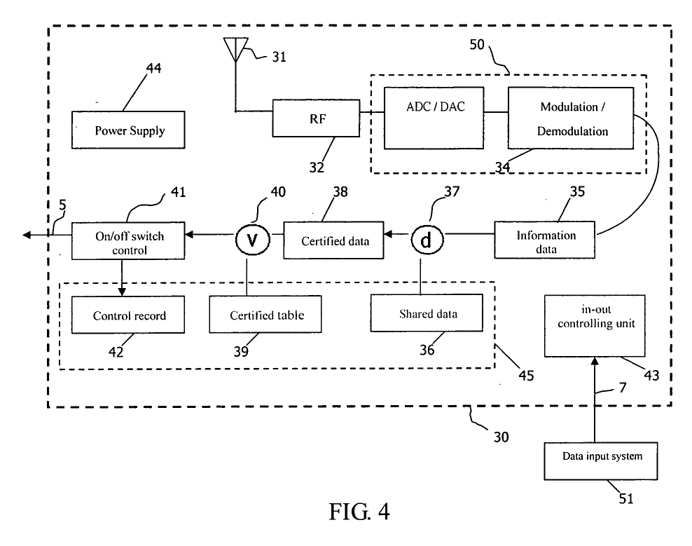

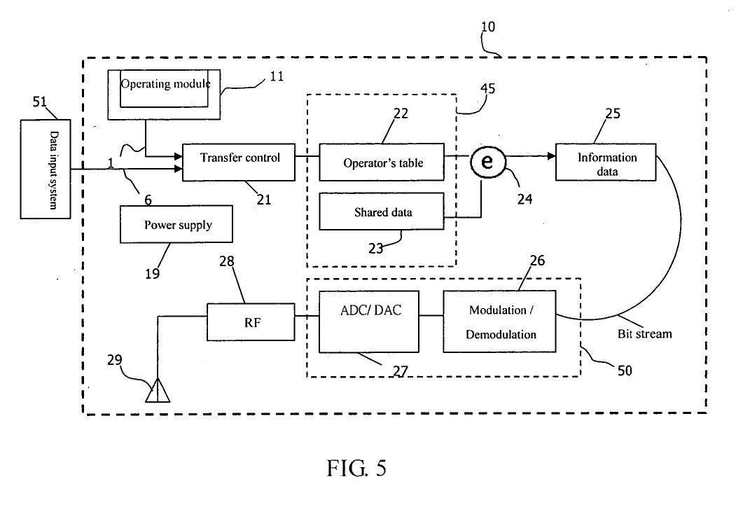

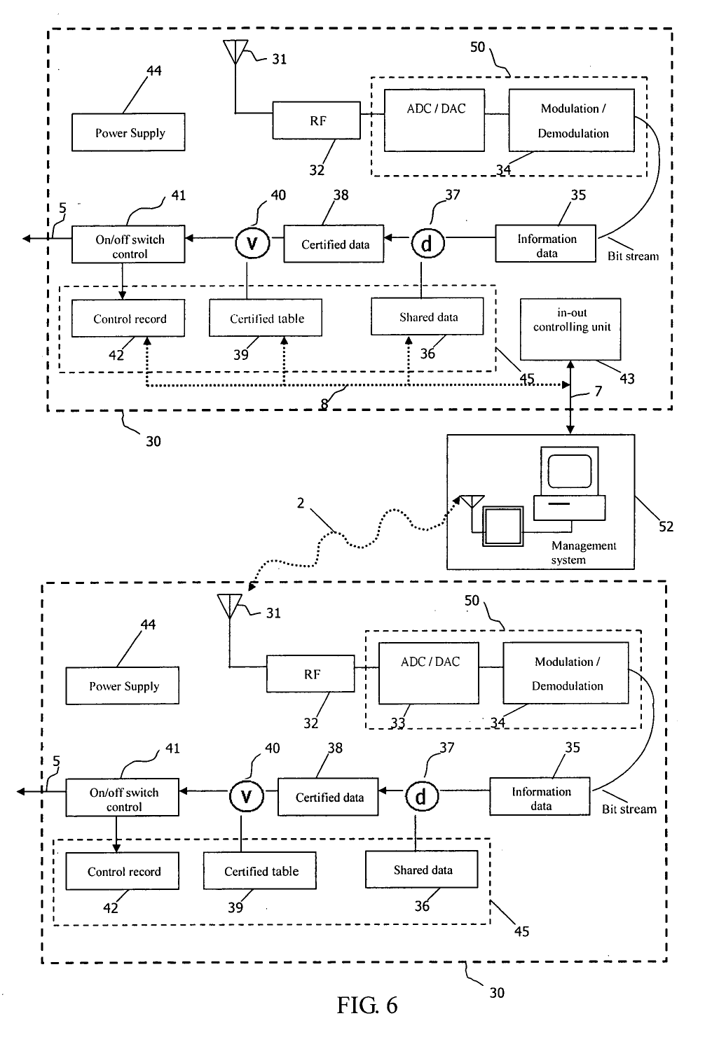

Below the FIG. 4, FIG. 5 and FIG. 6 will skip the modulation/demodulation 26/34, information data 25/35 and editing of certified data 38, and identification of certified contents as they are the same as the description in previous paragraph.

The second example in FIG. 4 explains another type of key-lock switch system. The key-lock control module 30 provides data line 7 to connect with external machines. The external data input system 51 inputs information data 35 through in-out controlling unit 43 to control the key-lock device which is connected with key-lock control module 30.

The third example in FIG. 5 is an function expansion for the first example and explains how to renew the data content of operator's table 22 in the electronic key 10. The user renews the data content of the operator's table 22 in the electronic key 10 through the data input system 51 which is an external machine and is connected with the electronic key 10 by data line 6. The transfer control 21 will transfer the renewed data content when the operating module 11 is operated.

The forth example in FIG. 6 is an added function to the first example and explains the management and maintenance of the invented key-lock switch system. The key-lock control module 30 provides a data line 7 to connect the external machine. The remote management system 52 may connect with the key-lock control module 30 through the data line 7 or radio frequency signals 2. The remote management system 52 may read, update, edit and delete 8 the content of the shared data 36, control record 42 and of the data of the certified table 39 of the memory 45 in the key-lock control module 30.

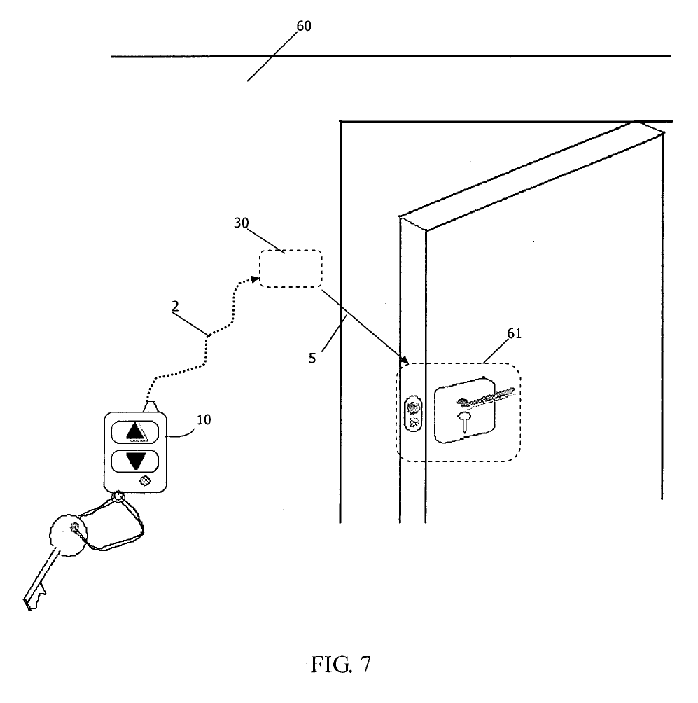

The FIG. 7 explains an example of how the invention applied in a building and explains, through output or cutoff electronic signals 5 to control the key-lock device, a second security protection method to open the door besides using the metal key. A building 60 equipped with key-lock control module 30. A user press the remote control key of the electronic key 10. One data content of the operator's table 22 corresponding with the pressed key is transmitted through radio frequency signals 2 which is edited by digital modulation process of the electronic key 10, and the key-lock control module 30 within the valid distance re-edits the information data 35 by digital demodulation, and the identification of identifying program the data passes mapping and identification, the on/off switch control 41 then output electronic signal 5 of key-lock device of passage 61 and opens the door of the passage, same as the metal key does.

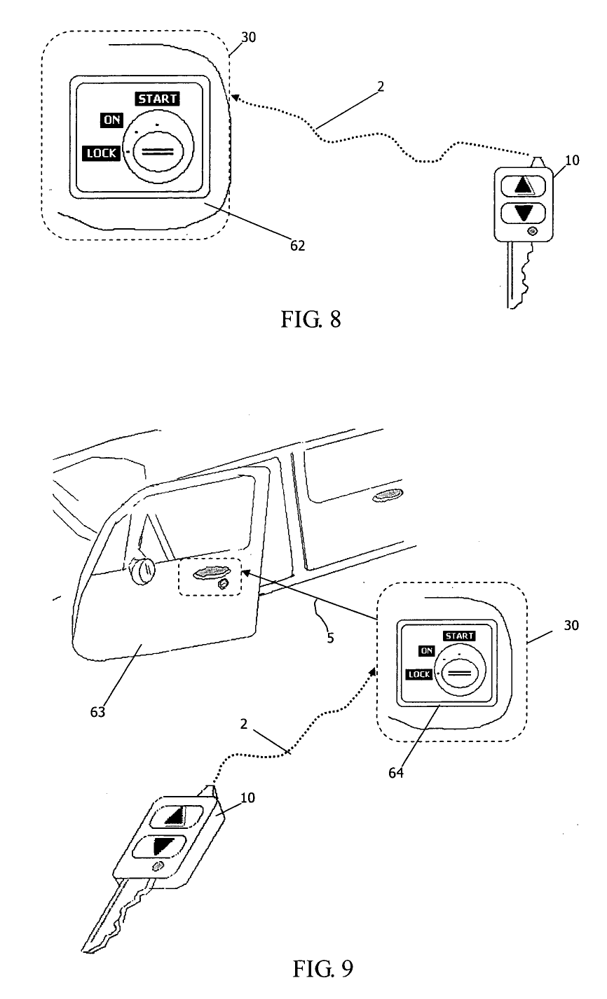

FIG. 8 explains an example used in motorcycles. A motorcycle equipped with a key-lock control module 30 of key-lock device of starting engine 62. The user may turn on/off the power supply of the key-lock device of starting engine 62 by using the remote control device which an electronic key 10 is equipped with and prevents the motorcycle from being stolen.

The FIG. 9 explains an example that the invention of key-lock switch system used in a vehicle. The user operates the remote control device which an electronic key 10 is equipped to open/shut up the door of a vehicle 63 and, at the same time, controls the power supply of the key-lock device of a vehicle's starting engine 64 by switching the control of the key-lock control module 30.

The above examples are for the explanation convenience and the range of rights and privileges claimed by the invention is described in the patent claim section and is not limited by the above examples.

Here I claim:

1. A system for controlling the key-lock switch by output or cutoff the electronic control signals to switch the key-lock device through editing the received/transmitted information data via spread frequency digital modulation/demodulation, said system comprises:
at least an electronic key which may be operable to transfer the information data, wherein each electronic key comprising an RF and an antenna that are located in the transmitting end through which one of a corresponding operator's data of a operator's table will be edited into information, and then the information data is transmitted as radio frequency signal after being edited by baseband coding technology and digital-to-analog convert technology; and
at least a key-lock control module, wherein each key-lock control module comprises an RF and an antenna that are located in the receiving end through which the radio frequency signals are received, and decoded by baseband analog-to-digital convert technology and coding technology, and edited into information data, and then the information data is re-edited as certified data which will be checked and compared one by one by identification program with the certified data table contained in the memory, if it is identified as the same certified data, the key-lock control module will output or cut-off the electronic control signals to open, to close or to switch the key-lock device from open to lock or from lock to open.

2. The system of claim 1, wherein a certified data, which is produced and saved into the certified table of the key-lock control module, is a data generated from, through the internal program of the key-lock control module and the information data which is edited from, through the internal program and the data of the operator's table of an electronic key that is corresponding to the key-lock control module, then the re-edited data will be saved into the certified table of the key-lock control module.

3. The system of claim 2, wherein a data is further protected and security re-enforced case, a certified data, which is produced and saved into the certified table of the key-lock control module, is a data generated from, through the internal decryption program, the shared data of the key-lock control module and the information data which is edited from, through the encryption program, the shared data and the data of the operator's table of an electronic key that is corresponding to the key-lock control module, then the re-edited data will be saved into the certified table of the key-lock control module.

4. The system of claim 1, wherein the certified table of a key-lock control module is able to store one or lots certified data edited through the certification process and the identification process for corresponding to the one or many different electronic keys.

5. The system of claim 1, wherein the operator's table of an electronic key, is able to store one or lots of operator's data with which the corresponding operator's data of the memory will be edited into information data and sent out when the user operates the operating nodule of the electronic key.

6. The system of claim 1, wherein the operator's table of the electronic key will store one or lots of operator's data for corresponding to one or many different key-lock control modules.

7. The system of claim 1, wherein that the reception/transmitting of radio frequency signals of spread frequency digital modulation/demodulation is executed with the unit composed of baseband, RF and antenna.

8. The system of claim 1, wherein the baseband provides functions of convert analog-to-digital and convert digital-to-analog and radio frequency signals of spread frequency digital modulation/demodulation

9. The system of claim 7, wherein the spread frequency is one of the following types: Direct Sequence Spread Spectrum (DSSS), Chirp Spread Spectrum (CSS), Frequency Hopping Spread Spectrum (FHSS), Time Hopping Spread Spectrum (THSS), Orthogonal Frequency Division Multiplexing (OFDM) and Packet Binary Convolutional Coding (PBCC).

10. The system of claim 1, wherein the memory of the key-lock control module will save the executed control contents and time as recorded data to show the entering, outing, usage situation and etc.

11. The system of claim 1, wherein the electronic key provides data lines to connect with external devices through which to do the external data input and renew the contents of the operator's table in the memory of the electronic key.

12. The system of claim 1, wherein the key-lock control module provides data lines to connect with external devices through which to control the key-lock device and manage/maintain the key-lock switch system as well.

13. The system of claim 1, wherein the electronic key provides data lines to connect with an external device and through which the external device may switch the open/close action of a remote key-lock device that is equipped with a key-lock control module by inputting operator's data or information data.

14. The system of claim 1, wherein the key-lock control module provides data lines to connect with an external device and through which the external device may switch the open/close action of a key-lock device that is equipped with a key-lock control module by inputting certified data or information data.

15. The system of claim 1, wherein the maintenance of control records, the shared decryption data, and the content of the certified table in the memory of the key-lock control module is executed by an external management system through the connected data lines or through the radio frequency signal transfer.
